(19) United States
(12) Patent Application Publication
(10) Pub. No.: US 2016/0306925 A1
(43) Pub. Date: Oct. 20, 2016

(54) METHOD AND SYSTEM FOR PERFORMING QUALITY CONTROL TESTING OF MEDICAL IMAGING STUDIES

(71) Applicant: Synaptive Medical (Barbados) Inc., Bridgetown (BB)

(72) Inventors: Steven Richard Wranovsky, Muskego, WI (US); Thanh Duc Huynh, Markham (CA); Sheryl Rae Thingvold, Toronto (CA)

(21) Appl. No.: 14/685,995

(22) Filed: Apr. 14, 2015

(51) Int. Cl. G06F 19/00

(52) U.S. Cl. CPC G06F 19/321; G06F 19/3412; G06F 19/366

(57) ABSTRACT

A quality control system for performing quality control checks on pre-scheduled medical imaging studies. The system includes a processor and an interface for receiving electronic orders, each order specifying a medical imaging procedure to be performed at a specified procedure time to produce a study. The processor performs a series of functions for each electronic order. It first determines whether the study to be produced by the specified procedure according to the order requires a quality control check. Then, if the study requires a quality control check, the processor waits until a decision time that is the earlier of the time that the study becomes available for performing a quality control check, and a period of time after the specified procedure time. If, at the decision time, the study is available for performing a quality control check, then the processor performs the quality control check on the study.

### FIELD OF THE INVENTION

The present invention relates generally to systems for performing image quality control checking, and more particularly to systems for performing image quality control checking on medical imaging studies whose production is monitored by the system.

### BACKGROUND OF THE INVENTION

Within medical imaging, there are cases where an imaging procedure is performed for use by specialists outside of radiology. These imaging studies may be archived in a departmental picture archival and communication system (PACS). Two problems may arise. First, the medical imaging studies may not even be received by the departmental PACS system due to workflow inefficiencies within the facility. Secondly, the study may not be performed to the requirements of the specialist. When this occurs, the patient often has to return for repeat scans. This can cause delays in treatment of the patient and repeat scans with the potential exposure of additional radiation. The problem reduces the quality of care to the patient and increases the cost of care.

### SUMMARY OF THE INVENTION

In some embodiments, the present disclosure provides a method of performing quality control checks on pre-scheduled medical imaging studies. The method is performed by a computer processor. The first step is receiving an electronic order specifying a medical imaging procedure to be performed at a specified procedure time to produce a study. Then it is determined whether the study to be produced by the specified procedure requires a quality control check. If the study requires a quality control check, then the processor waits until a decision time that is the earlier of (i) the time that the study becomes available for performing a quality control check, and (ii) a predetermined period of time after the specified procedure time. Then, if at the decision time the study is available for performing a quality control check, the processor performs the quality control check on the study.

The processor preferably provides a notification to an administrator if at the decision time the study is not available for performing a quality control check. For example, the processor may send an electronic message to a predetermined address if at the decision time the study is not available for performing a quality control check, the electronic message indicating that the study was not available for performing a quality control check at the predetermined period of time after the specified procedure time. The electronic message may be an email message. The predetermined address may be an email address, for example of an administrator, such as a hospital administrator.

The processor may further send an electronic message to a predetermined address if the study did not pass the quality control check, the electronic message indicating that the study did not pass the quality control check.

The processor may further send an electronic message to the predetermined address if the study did pass the quality control check, the electronic message indicating that the study did pass the quality control check.

The processor may determine whether the study to be produced requires a quality control check by comparing the specified procedure with a list of procedures that require quality control checks to be performed.

The processor may determine whether the study to be produced requires a quality control check by checking a field in the order indicating that a quality control check is or is not required. The field may contain words indicating the reason for producing the study, and determining whether the study to be produced requires a quality control check may then be done by analyzing the words to find words or phrases that imply the need to perform a quality control check.

The order may be an HL7 order relayed from a hospital electronic medical record.

The specified medical imaging procedure may involve diffusion tensor imaging (DTI) performed according to a set of magnetic resonance (MR) parameters, so that the study to be produced is a DTI study, and performing the quality control check on the study may then involve analyzing the MR parameters to ensure the data collected by the DTI is adequate to use to produce three-dimensional images of sufficient quality for use in surgical planning. The quality control check on the DTI study may be performed by checking that each image produced by the DTI has a slice thickness within a pre-determined range of values. Performing the quality control check on the DTI study may involve checking that each image produced by the DTI has a resolution of at least a pre-determined level.

In some embodiments, the present disclosure provides a quality control system for performing quality control checks on pre-scheduled medical imaging studies. The system includes an electronic interface for receiving electronic orders. The system includes a computer processor that is configured to perform a series of functions. The processor is configured to receive an order via the electronic interface, the order specifying a medical imaging procedure to be performed at a specified procedure time to produce a study. It then determines whether the study to be produced by the specified procedure according to the order requires a quality control check. Then, if the study requires a quality control check, the processor waits until a decision time that is the earlier of (i) the time that the study becomes available for performing a quality control check, and (ii) a predetermined period of time after the specified procedure time. If, at the decision time, the study is available for performing a quality control check, then the processor performs the quality control check on the study.

The system's computer processor may be further configured to send a warning message via the electronic interface to a predetermined address if at the decision time the study is not available for performing a quality control check, the electronic message indicating that the study was not available for performing a quality control check at the predetermined period of time after the specified procedure time. The system's computer processor may be further configured to send an electronic message to a predetermined address if the study did not pass the quality control check, the electronic message indicating that the study did not pass the quality control check. The system's computer processor may be further configured to send an electronic message to the predetermined address if the study did pass the quality control check, the electronic message indicating that the study did pass the quality control check.

The system's computer processor may determine whether the study to be produced requires a quality control check by comparing the specified procedure with a list of procedures that require quality control checks to be performed.

The system's computer processor may determine whether the study to be produced requires a quality control check by checking a field in the order indicating that a quality control check is or is not required. The field may contain words indicating the reason for producing the study, and determining whether the study to be produced requires a quality control check may then involve analyzing the words to find terms that imply the need to perform a quality control check.

The system may further include a digital imaging and communications in medicine (DICOM) server configured to receive the pre-scheduled medical imaging studies. In that case, each study is deemed to be available for performing a quality control check when it is received by the DICOM server.

### BRIEF DESCRIPTION OF THE DRAWINGS

FIG. 1 depicts a flow chart of an embodiment of a method of performing quality control checks on pre-scheduled medical imaging studies showing the major decision points and events.

FIG. 2 depicts a flow chart of an embodiment of a method of performing quality control checks on medical imaging studies as the studies are received, showing the major decision points and events.

FIG. 3 depicts a departmental PACS server with integrated quality control functionality.

### DETAILED DESCRIPTION OF THE INVENTION

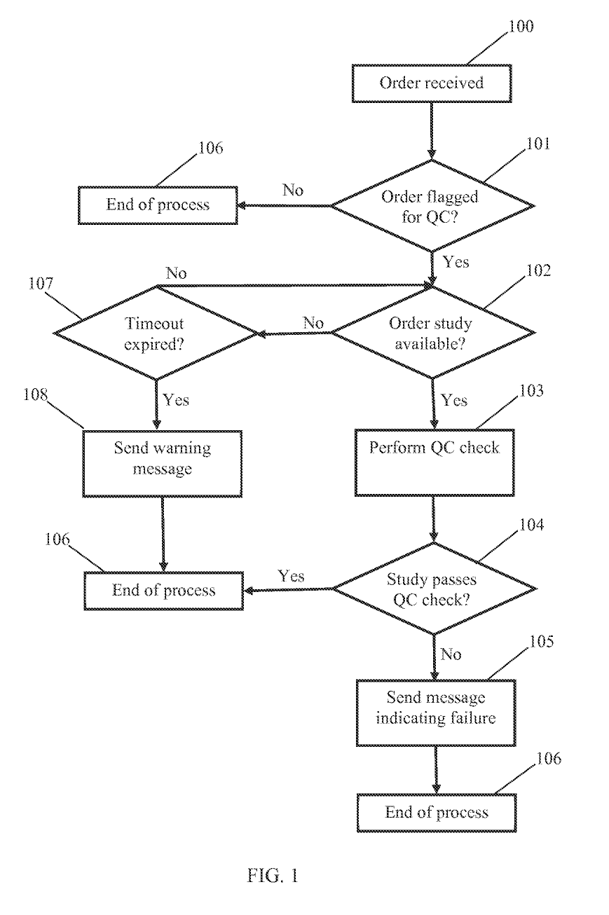

The algorithm employed in some preferred embodiments of the quality control system (and associated methods) is depicted in the flow chart provided as FIG. 1. The system that performs the disclosed methods preferably includes a computer processor that may be customized to perform the functionality disclosed herein by software that runs on the computer processor. A quality control system employing the disclosed methods may be a standalone system or may be integrated within a system that performed other functions. For example, as discussed below, quality control system may be implemented by a module in a system that includes a DICOM server.

The processing may be order-driven in that the receipt of an electronic order 100 triggers the process depicted in FIG. 1. Each order specifies a medical imaging procedure to be performed at a specified procedure time to produce a study. The specified procedure time is typically the scheduled time that a radiological study is planned to be performed on the patient as indicated in the order using a specific imaging modality. Imaging modalities may, employ, for example, X-ray radiography, magnetic resonance imaging (MRI), medical ultrasonography or ultrasound, endoscopy, elastography, tactile imaging, thermography, medical photography and nuclear medicine functional imaging techniques as positron emission tomography. A procedure normally specifies an imaging modality and the body part(s) to be imaged. For example, a procedure named “MRI HEAD” may specify a requirement to generate a study of the patient's head using MRI. A procedure named “MRI BODY” may specify a requirement to generate a study of the patient's entire body using MRI.

Such orders are typically formatted and transmitted according to the Health Level-7 or HL7 standard for transfer of clinical and administrative data between software applications used by various healthcare providers. In that case, the electronic orders are HL7 order messages (HL7 ORM). An HL7 ORM can be used to create a radiology request, and also to amend or cancel such a request. The completion of a procedure may be indicated by the transmission of an HL7 result message (HL7 ORU) indicting that the radiology report associated with the procedure is available.

The performance of a specified procedure results in the creation of a DICOM study, which generally includes multiple DICOM series, where each series includes a number of DICOM images containing the images produced by the imaging modality. One series may include hundreds of large image files.

It may be required, as a matter of protocol, to perform certain quality control checks on studies produced pursuant to an order in order to help ensure that the study is suitable for the intended purpose. The need for performing a quality control check for a given study may be implied by the specific procedure indicated in the order to be used to produce the study. For example, MRI HEAD procedures may always require a quality control check to be performed. Alternatively or additionally, the need for performing a quality control check may be indicated otherwise in the order. For example, the order may contain a field that indicates the reason for performing the procedure. Then it may be the case that if the reason includes surgical planning, then a quality control check is required. The system can determine this by analyzing the words, for example, in a “reason for study” field in the order. In some embodiments, a field in the order may simply specify directly that a quality control check is required.

The nature of the required quality control checks varies based on the type of procedure, but suitable quality control checks for common procedures/modalities are generally well known to skilled persons.

One example of quality control checks are those normally conducted for Diffusion Tensor Imaging (DTI) studies. These magnetic resonance (MR) studies detect waterflow within a patient's brain. The studies can be used to create a three dimensional image of the tracts within the brain to help with surgical planning. The quality of the three dimensional image is dependent on the parameters used by the MR scanner. Without a high quality three dimensional image, the surgical planning process may be hindered. There is also a time consuming computation that must take place on the original MR images. To help ensure successful surgical planning, a quality control check is done to ensure the parameters of the MR scan support creation of three dimensional images. These checks may include checks such as the following.
Ensuring the slice thickness of each image within the scan is within a predefined range of values. The slice thickness requirements may be different for T1 scans, T2 scans, and the diffusion weighted scans.
Ensuring that the DTI study uses a pre-determined minimum number of diffusion weighting gradients as part of scan. These gradients are what are used as part of the MR scan to detect waterflow, and the quality of the detection of waterflow is not as high if the number of gradients is too low. This in turn may cause the three dimensional images to not be of sufficiently high quality.
Ensuring that the images being generated are at a sufficiently high resolution to create high quality three dimensional images.
Ensuring that the entire head of the patient is covered by the exam.

These parameters are set and are configurable for different types of MR scanners. They can be changed and adjusted as the needs for surgical planning change.

Returning now to FIG. 1, when an order to perform a procedure is received 100, the order is analyzed to determine if the order should be flagged for a quality control check 101. As discussed above, this may be done by checking whether the procedure specified in the order is one for which a quality control check is always required. Alternatively or additionally, determining whether the study to be produced requires a quality control check may be performed by checking a field in the order indicating that a quality control check is or is not required. Based on such an analysis, the order is either not flagged for a quality control check, in which case the process ends 106, or it is flagged for a quality control check.

If the order is flagged for a quality control check, then the system may periodically check whether the study to be produced according to the order is available 102 or may simply wait until notification that the study is available is received, or until a predetermined amount of time after the scheduled time for performing the procedure specified in the order has elapsed. If this predetermined amount of time has elapsed (“timeout expired?” 107) before the study is available, then a warning message is sent 108 and the process terminates for that order 106. Alternatively, rather than waiting for a notification that the study is available, the system may periodically check the status of the study to see whether it is available on the DICOM server it was to be stored in. The predetermined amount of time may be selected to be the maximum expected time it takes for such procedures to be made available after the scheduled start time. It may alternatively be determined based on analysis of a sample of actual measured times for such studies produced by a particular procedure to become available. For example the predetermined amount of time for a procedure might be set to the 98^{th} percentile of measured times.

The warning message is generally an electronic message sent by the computer processor (or software running on a computer processor) of the system performing the process. This is preferably an email message sent to a pre-determined email address, or multiple addresses. For example it may be the email address of a hospital administrator. Alternatively or additionally, the system may update a database containing a list of orders received by the system to indicate that the study was not received by the expected time. A hospital administrator may periodically review the database, for example via a user interface that shows all such overdue studies in a highlighted fashion as an alternative means of alerting the administration to the problem. The user interface may allow the user to view all orders processed by the system and display a status field that indicates whether each study is available, whether a quality control check was required to be done on the study, and if a quality control check was required to be done on the study then also indicate the status of the quality control check. Such a user interface is preferably part of the system.

If the order study is available before the pre-determined amount of time after the specified procedure time 102, then the system automatically performs a quality control check 103, as discussed above. If the study passes the quality control check 104, the process may terminate for that order 106. Optionally, prior to the process for that order terminating, the system may send an electronic message to a predetermined address, such as an email address, indicating that the quality control check was successful. If the study did not pass (i.e. failed) the quality control check 104, then the system preferably sends an electronic message indicating the failure 105, and then the process for that order ends 106. Additionally, or alternatively, notification of the status of pending and completed quality control checks may be provided by a user interface, as discussed above.

In some embodiments, after sending a warning message 108 indicating that the predetermined amount of time after the scheduled time for performing the procedure specified in the order has elapsed, the system may continue to check for availability of the study to be produced by the procedure according to the associated order. In that case, then if the study does later become available, the process may continue as described above, with performing a quality control check 103, and sending messages advising of the status after the check has been performed, or otherwise providing notification of the status of the check.

It should be understood that a key inventive concept of the present invention is the monitoring of orders as they are issued so that not only can a quality control check be automatically performed when the associated study becomes available, but also the system notifies the relevant personnel about studies that are overdue for which quality control checks are required. This notification, for example, allows an administrator to attempt to resolve the problem with the study not being present on the system in a timely manner.

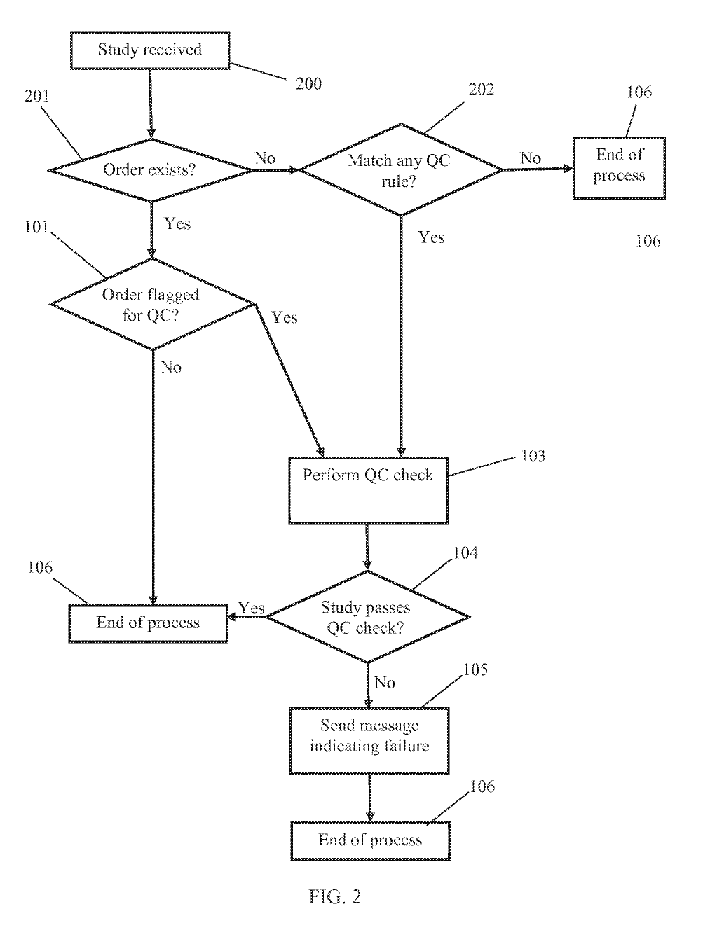

The quality control process may further incorporate study-driven processing via a process such as that depicted in FIG. 2, which may be integrated with the order-driven process depicted in FIG. 1. When a study is received 200, the system checks a list of orders that it has stored as the orders are received to see when an order corresponding to the study exists 201. If such an order exists 201, then the process proceeds as described above. If an order does not exist, then the system checks a set of pre-defined rules to determine if a quality control check is needed anyway. For example, a rule may specify that quality control checks are to be performed on studies where the value of the Referring Physician tag is X. If no such rule applies 202, then the process ends 106. If a rule does apply 202, then a quality control check is performed 103 as described above.

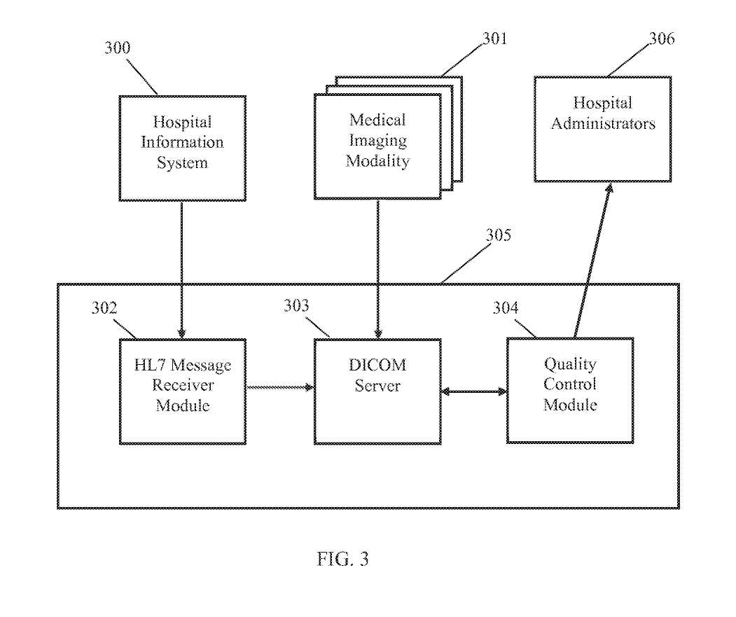

The quality control system may be integrated as a quality control module 305 into a system 305 having a DICOM server 303, and an HL7 message receiver module 302, as depicted in FIG. 3. The HL7 message receiver module 302 receives HL7 electronic orders from hospital information systems 300 via a network, such as a hospital local area network, for example via an Ethernet interface in the system 305. The quality control module 304 then performs the functions described above and depicted in FIG. 1 as HL7 orders are received by the HL7 message receiver module 302, sending warning and status messages to hospital administrators 306, or otherwise notifying them, based on the events discussed above. The quality control module 305 may maintain a database of pending and completed orders in which it maintains the study and quality control check status of each order. The quality control module 305 may also provide a user interface, as discussed above that permits users, such as hospital administrators 306, to check and monitor the status of orders.

In a preferred embodiment, when the DICOM server 303 receives a new imaging study, the quality control module 305 is notified and it then checks whether an order for that study is pending. If a matching order is found that is flagged for a quality control check, the system then applies these quality control checks, as described above. An output report is generated by the quality control module 305 that can be distributed to appropriate administrators.

The quality control module 305 may further be configured to produce statistics, for example, summarizing how successful a department is in generating studies that are satisfactory for the specialist (i.e. that pass the required quality control check). Statistics may be generated for a time range that, for example, states how many orders in the time range were intended for quality control, how many studies were received that failed quality control checks, and how many studies were received that passed quality control checks.

Embodiments of the invention may be configured for use in other environments, such as in clinical trials. There are reported problems in various clinical trials where imaging studies have been performed without to correct parameters having been used. Having quicker quality control of these scans with the results sent to administrators by an embodiment of the invention would be useful and helpful in preventing the need to re-scan patients.

Generally, a computer, computer system, computing device, client or server, as will be well understood by a person skilled in the art, includes one or more than one computer processor, and may include separate memory, and one or more input and/or output (I/O) devices (or peripherals) that are in electronic communication with the one or more processor(s). The electronic communication may be facilitated by, for example, one or more busses, or other wired or wireless connections. In the case of multiple processors, the processors may be tightly coupled, e.g. by high-speed busses, or loosely coupled, e.g. by being connected by a wide-area network.

A computer processor, or just “processor”, is a hardware device for performing digital computations. A programmable processor is adapted to execute software, which is typically stored in a computer-readable memory. Processors are generally semiconductor based microprocessors, in the form of microchips or chip sets. Processors may alternatively be completely implemented in hardware, with hard-wired functionality, or in a hybrid device, such as field-programmable gate arrays or programmable logic arrays. Processors may be general-purpose or special-purpose off-the-shelf commercial products, or customized application-specific integrated circuits (ASICs). Unless otherwise stated, or required in the context, any reference to software running on a programmable processor shall be understood to include purpose-built hardware that implements all the stated software functions completely in hardware.

While some embodiments or aspects of the present disclosure may be implemented in fully functioning computers and computer systems, other embodiments or aspects may be capable of being distributed as a computing product in a variety of forms and may be capable of being applied regardless of the particular type of machine or computer readable media used to actually effect the distribution.

At least some aspects disclosed may be embodied, at least in part, in software. That is, some disclosed techniques and methods may be carried out in a computer system or other data processing system in response to its processor, such as a microprocessor, executing sequences of instructions contained in a memory, such as ROM, volatile RAM, non-volatile memory, cache or a remote storage device.

A non-transitory computer readable storage medium may be used to store software and data which when executed by a data processing system causes the system to perform various methods or techniques of the present disclosure. The executable software and data may be stored in various places including for example ROM, volatile RAM, non-volatile memory and/or cache. Portions of this software and/or data may be stored in any one of these storage devices.

Examples of computer-readable storage media may include, but are not limited to, recordable and non-recordable type media such as volatile and non-volatile memory devices, read only memory (ROM), random access memory (RAM), flash memory devices, floppy and other removable disks, magnetic disk storage media, optical storage media (e.g., compact discs (CDs), digital versatile disks (DVDs), etc.), among others. The instructions can be embodied in digital and analog communication links for electrical, optical, acoustical or other forms of propagated signals, such as carrier waves, infrared signals, digital signals, and the like. The storage medium may be the internet cloud, or a computer readable storage medium such as a disc.

Furthermore, at least some of the methods described herein may be capable of being distributed in a computer program product comprising a computer readable medium that bears computer usable instructions for execution by one or more processors, to perform aspects of the methods described. The medium may be provided in various forms such as, but not limited to, one or more diskettes, compact disks, tapes, chips, USB keys, external hard drives, wire-line transmissions, satellite transmissions, internet transmissions or downloads, magnetic and electronic storage media, digital and analog signals, and the like. The computer usable instructions may also be in various forms, including compiled and non-compiled code.

At least some of the elements of the systems described herein may be implemented by software, or a combination of software and hardware. Elements of the system that are implemented via software may be written in a high-level procedural language such as object oriented programming or a scripting language. Accordingly, the program code may be written in C, C++, J++, or any other suitable programming language and may comprise modules or classes, as is known to those skilled in object oriented programming. At least some of the elements of the system that are implemented via software may be written in assembly language, machine language or firmware as needed. In any case, the program code can be stored on storage media or on a computer readable medium that is readable by a general or special purpose programmable computing device having a processor, an operating system and the associated hardware and software that is necessary to implement the functionality of at least one of the embodiments described herein. The program code, when read by the computing device, configures the computing device to operate in a new, specific and predefined manner in order to perform at least one of the methods described herein.

While the teachings described herein are in conjunction with various embodiments for illustrative purposes, it is not intended that the teachings be limited to such embodiments. On the contrary, the teachings described and illustrated herein encompass various alternatives, modifications, and equivalents, without departing from the described embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed.

The words “comprises” and “comprising”, when used in this specification and the claims, are to used to specify the presence of stated features, elements, integers, steps or components, and do not preclude, nor imply the necessity for, the presence or addition of one or more other features, elements, integers, steps, components or groups thereof.

What is claimed is:

1. An order-driven method of performing quality control checks on pre-scheduled medical imaging studies, the method being performed by a computer processor, the method comprising the steps of:
(a) receiving an electronic order specifying a medical imaging procedure to be performed at a specified procedure time to produce a study;
(b) determining whether the study to be produced by the specified procedure requires a quality control check;
(c) if the study requires a quality control check, waiting until a decision time that is the earlier of (i) the time that the study becomes available for performing a quality control check, and (ii) a predetermined period of time after the specified procedure time; and
(d) if at the decision time the study is available for performing a quality control check, then performing the quality control check on the study.

2. The method of claim 1, further comprising providing a notification to an administrator if at the decision time the study is not available for performing a quality control check.

3. The method of claim 1, further comprising sending an electronic message to a predetermined address if at the decision time the study is not available for performing a quality control check, the electronic message indicating that the study was not available for performing a quality control check at the predetermined period of time after the specified procedure time.

4. The method of claim 1, further comprising providing a user interface that allows a user to view the status of electronic orders processed by the method, wherein if at the decision time the study is not available for performing a quality control check, the status shown to the user indicates that the study was not available for performing a quality control check at the decision time.

5. The method of claim 1, further comprising sending an electronic message to a predetermined address if the study did not pass the quality control check, the electronic message indicating that the study did not pass the quality control check.

6. The method of claim 5, further comprising sending an electronic message to the predetermined address if the study passed the quality control check, the electronic message indicating that the study passed the quality control check.

7. The method of claim 1, wherein determining whether the study to be produced requires a quality control check is performed by comparing the specified procedure with a list of procedures that require quality control checks to be performed.

8. The method of claim 1, wherein determining whether the study to be produced requires a quality control check is performed by checking a field in the order indicating that a quality control check is or is not required.

9. The method of claim 8, wherein the field contains words indicating the reason for producing the study, and determining whether the study to be produced requires a quality control check comprises analyzing the words to find words or phrases that imply the need to perform a quality control check.

10. The method of claim 1, wherein the order is an HL7 order relayed from a hospital electronic medical record.

11. The method of claim 1, further comprising the steps of receiving a study that is not associated with any received order, checking whether the study matches any of a set of pre-defined quality control rules, and if the study matches one of the pre-defined quality control rules, then performing the quality control check on the study.

12. The method of claim 1, wherein the specified medical imaging procedure comprises diffusion tensor imaging (DTI) performed according to a set of magnetic resonance (MR) parameters, the study to be produced being a DTI study, wherein performing the quality control check on the DTI study comprises analyzing the MR parameters to ensure the data collected by the DTI is adequate to use to produce three-dimensional images of sufficient quality for use in surgical planning.

13. The method of claim 12, wherein performing the quality control check on the DTI study comprises checking that each image produced by the DTI has a slice thickness within a pre-determined range of values.

14. The method of claim 12, wherein performing the quality control check on the DTI study comprises checking that each image produced by the DTI has a resolution of at least a pre-determined level.

15. A quality control system for performing quality control checks on pre-scheduled medical imaging studies, the system comprising:
an electronic interface for receiving electronic orders; and
a computer processor configured, for each electronic order, to:
(a) receive an order via the electronic interface, the order specifying a medical imaging procedure to be performed at a specified procedure time to produce a study;
(b) determine whether the study to be produced by the specified procedure according to the order requires a quality control check;
(c) if the study requires a quality control check, wait until a decision time that is the earlier of (i) the time that the study becomes available for performing a quality control check, and (ii) a predetermined period of time after the specified procedure time; and
(d) if at the decision time the study is available for performing a quality control check, then perform the quality control check on the study.

16. The system of claim 15, wherein the computer processor is further configured to send a warning message via the electronic interface to a predetermined address if at the decision time the study is not available for performing a quality control check, the electronic message indicating that the study was not available for performing a quality control check at the predetermined period of time after the specified procedure time.

17. The system of claim 15, wherein the computer processor is further configured to send an electronic message to a predetermined address if the study did not pass the quality control check, the electronic message indicating that the study did not pass the quality control check.

18. The system of claim 15, wherein the computer processor determines whether the study to be produced requires a quality control check by comparing the specified procedure with a list of procedures that require quality control checks to be performed.

19. The system of claim 15, wherein the order is an HL7 order relayed from a hospital electronic medical record.

20. The system of claim 15, further comprising a digital imaging and communications in medicine (DICOM) server configured to receive the pre-scheduled medical imaging studies, each study being available for performing a quality control check when it is received by the DICOM server.
